(19) United States
(12) Patent Application Publication
(10) Pub. No.: US 2008/0316345 A1
(43) Pub. Date: Dec. 25, 2008

(54) IMAGING ELEMENT AND IMAGING DEVICE

(76) Inventor: Tatsuo ONODERA, Kurokawa-gun (JP)

Correspondence Address: BIRCH STEWART KOLASCH & BIRCH, PO BOX 747, FALLS CHURCH, VA, 22040-0747, US

(21) Appl. No.: 12/142,355

(22) Filed: Jun. 19, 2008

(30) Foreign Application Priority Data
Jun. 22, 2007 (JP) P2007-164728

(51) Int. Cl. H04N 5/335

(52) U.S. Cl. 348/294; 348/E05.091

(57) ABSTRACT

An imaging element and an imaging device of the present invention have photoelectric conversion sections arranged two-dimensionally with respect to the surface of a semiconductor substrate; a color filter layer that is made up of a plurality of color filters for decomposing incident light into different colors and brightness filters for causing light including all color components to pass and where the plurality of color filters and the brightness filters are arranged at positions above the photoelectric conversion sections; vertical charge transfer sections linearly extended so as to transfer signal charges read from the respective photoelectric conversion sections; reading regions for reading signal charges generated by the photoelectric conversion sections to the vertical charge transfer sections; and light-shielding films that are provided so as to cover the vertical charge transfer sections and that have opening sections located above the respective photoelectric conversion sections. The opening sections of the light-shielding films of the pixels where the color filters are disposed are formed so as to become smaller than the opening sections of the pixels having the brightness filter in terms of a horizontal distance between the reading region of the adjacent pixel and an open edge of the opening section.

### BACKGROUND OF THE INVENTION

1. Field of the Invention

The present invention relates to an imaging element and an imaging device and, more particularly, to an imaging element and an imaging device that enhance optical sensitivity by increasing amounts of received light while preventing occurrence of smear.

2. Description of the Related Art

For example, an imaging element having a CCD configuration shown in FIG. 6 is available as an imaging element used for an image sensor of a digital camera. A photoelectric conversion section 103 is placed on a front side of the imaging element 101 that is a side of a semiconductor substrate 102, which is formed from silicon, or the like, to be exposed to incident light. The photoelectric conversion sections is provided with a charge storage region 103a consisting of a heavily-concentrated p-type impurity layer and a photoelectric conversion region 103b consisting of an n-type impurity layer formed below the electric charge storage region 103a. The photoelectric conversion sections 103 perform photoelectric conversion in accordance with received incident light, to thus generate signal charges. Further, heavily-concentrated n-type impurity layers 105a and well regions 105b created below the respective n-type impurity layers 105a are provided on a front side of the semiconductor substrate 102 by way of the photoelectric conversion sections 103 and element isolation regions 104, and each set consisting of the impurity layer 105a and the well region 105b acts as a charge transfer region 105. Vertical transfer electrodes 106 are provided at respective positions on the semiconductor substrate 102 above the respective impurity layers 105a. Light-shielding films 107 for shielding the vertical transfer electrodes from the incident light are provided above the respective vertical transfer electrodes 106, and opening sections 107a for allowing passage of incident light are created at respective positions of the light-shielding film 107 located above the respective photoelectric conversion sections 103. A transparent insulation layer 111 and a color filter layer 108 are stacked on the surface of the semiconductor substrate 102, and micro lenses 109 are formed for the respective photoelectric conversion sections 103 and on the surface of the color filter 108. A related-art device having imaging elements of such a configuration is described in; for example, JP-A-2005-117008 and JP-A-7-50401.

Incidentally, the imaging element 101 can increase amounts of incident light radiated on the photoelectric conversion sections 103 by means of increasing open areas of the opening sections 107a. However, there is an apprehension that smear becomes prone to arise for reasons of the charge transfer regions 105a of the adjacent pixels being exposed to light as a result of leakage of incident light from a space between the light-shielding films 107 and the surface of the semiconductor substrate 102. Thus, a limitation is imposed on the size of the open area because of a necessity for preventing occurrence of pseudo-color, which would otherwise be caused by smear. Improvements for preventing occurrence of pseudo-color, which would otherwise be caused by smear, and further enhancing optical sensitivity and brightness shading (inconsistencies in brightness) have been sought.

### SUMMARY OF THE INVENTION

The present invention has been conceived in view of the circumstance and aims at providing an imaging element and an imaging device that can prevent occurrence of smear and enhance optical sensitivity.

The objective of the present invention is achieved by the following configurations.

(1) An imaging element that generates a signal charge by photoelectric conversion of incident light in each of a plurality of pixels provided in an imaging region, the element comprising: a semiconductor substrate; a plurality of photoelectric conversion sections arranged two-dimensionally on a surface of a semiconductor substrate; a color filter layer that comprises (i) a plurality of color filters that decomposes incident light into different colors and (ii) a plurality of brightness filters that causes light including all color components to pass, said plurality of color filters and said plurality of brightness filters being arranged at positions above said plurality of photoelectric conversion sections respectively so as to form the pixels; vertical charge transfer sections linearly extended so as to transfer signal charges read from said plurality of respective photoelectric conversion sections; reading regions that respectively read signal charges generated by the photoelectric conversion sections to the vertical charge transfer sections; and light-shielding films that are provided so as to cover the vertical charge transfer sections and have opening sections located above the respective photoelectric conversion sections, wherein the opening sections comprises: first opening sections that correspond to a first subset of ones of the pixels in which the color filters are disposed; and second opening sections that correspond to a second subset of ones of the pixels in which the brightness filters are disposed, and wherein when a horizontal distance between: an edge of one of the second opening sections which corresponds to first one of the second subset of ones of the pixels; and one of the reading regions which corresponds to first one of the first subset of ones of the pixels, the first one of the first subset of ones of the pixels being adjacent to the first one of the second subset of ones of the pixels, is a first distance, and when a horizontal distance between: an edge of one of the first opening sections which corresponds to second one of the first subset of ones of the pixels; and one of the reading regions which corresponds to second one of the second subset of ones of the pixels, the second one of the second subset of ones of the pixels being adjacent to the second one of the first subset of ones of the pixels, is a second distance, the first distance is smaller than the second distance.

(2) The imaging element defined in (1), wherein said plurality of color filters are color filters that decompose incident light into red, green, and blue colors, and the color filters and the brightness filters are arranged in a grid pattern at essentially equal intervals in both vertical and horizontal directions of the imaging region.

(3) The imaging element defined in (1), wherein said plurality of color filters are color filters that decompose incident light into red, green, and blue colors, the color filters are arranged in a grid pattern at essentially equal intervals in both vertical and horizontal directions of the imaging region, and the brightness filters are arranged in a grid pattern so as to become offset from each other at one-half of each of the vertical and horizontal intervals of the color filters.

(4) An imaging device having the imaging element defined in any one of (1) through (3).

An imaging element of the present invention has a configuration that enables detection of color information from light, which is obtained as a result of incident light being decomposed by color filters and received by the photoelectric conversions sections and which has a predetermined color component, and that allows detection of brightness information from the light which has passed through the brightness filters and been received by the photoelectric conversion sections. The opening section of the light-shielding film provided above the photoelectric conversion section in the pixel having a color filter differs in shape from the opening section of the light-shielding film in the pixel having the brightness filter. The opening section of the pixel having the color filter is made smaller than the opening section of the pixel having the brightness filter in terms of the horizontal distance between the reading area of the pixel having the brightness filter adjacent to the color filter and the open edge of the opening section, whereby the opening section can be formed so as to become greater toward the pixel having the brightness filter when the imaging element is viewed in a direction where incident light is radiated. Since the pixels having the brightness filter use signal charges in order to acquire brightness information. Hence, even if a portion of light falling on the color filter is radiated on the charge storage region of the pixel having the brightness filter adjacent to the color filter, a smear signal will not be generated, and a pseudo color will not arise. Moreover, the opening sections of the pixels having the color filters are increased, whereby amounts of light received by the photoelectric conversion sections can be increased. Hence, enhancement of optical sensitivity and improvement of brightness shading can be achieved.

### BRIEF DESCRIPTION OF THE DRAWINGS

FIG. 1 is a block diagram of an imaging device having an imaging element of the present invention;

FIG. 2 is a plan view simply showing the arrangement of pixels in an imaging area of the imaging element;

FIG. 3 is a cross-sectional view of the arrangement of the pixels in FIG. 2 when viewed in the direction of arrow I-I;

FIG. 4 is a cross-sectional view of the arrangement of the pixels in FIG. 2 when viewed in the direction of arrow II-II;

FIG. 5 is a plan view simply showing another arrangement pattern of pixels of the imaging element; and

FIG. 6 is a cross-sectional view illustrating the configuration of a related-art imaging element.

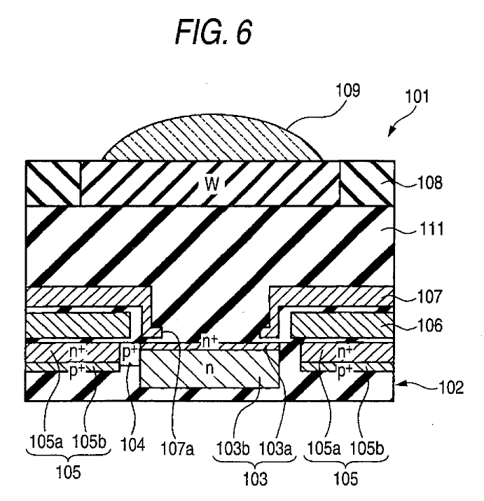

### DETAILED DESCRIPTION OF THE INVENTION

An embodiment of the present invention will be described hereunder in detail by reference to the drawings.

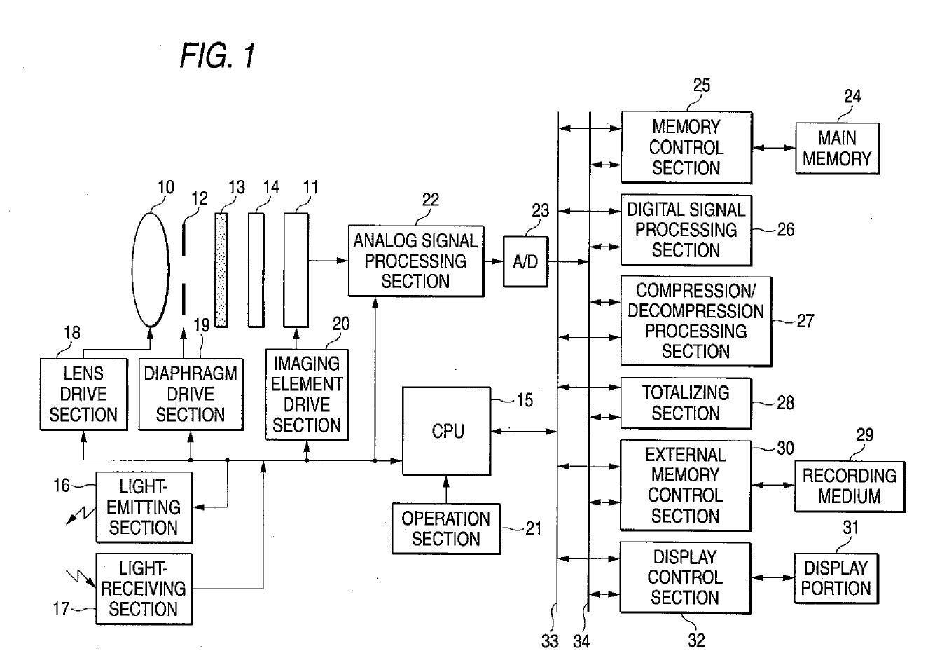

FIG. 1 is a block diagram of an imaging device having an imaging element of the present invention. In the present embodiment, an explanation is provided by means of taking a digital still camera as an example. However, the present invention can also be applied to digital cameras of other types, such as digital video cameras and cameras built in compact electronic devices, like portable cellular phones.

A digital still camera shown in FIG. 1 has an imaging lens 10; a CCD imaging element 11; a diaphragm 12 interposed therebetween; an infrared-radiation cut filter 13; and an optical low-path filter 14. A CPU 15 for controlling the entire digital still camera controls a light-emitting section 16 and a light-receiving section 17 for flashing purpose; controls the lens drive section 18, to thus adjust the position of the imaging lens 10 to a focusing position; and also controls an amount of opening of the diaphragm by way of a diaphragm drive section 19 such that an exposure level comes to an appropriate exposure level.

In the present embodiment, the imaging element 11 has a brightness detection pixel for detecting a brightness detection signal (W), as well as having a color pixel for detecting a signal conforming to an amount of incident light of red color (R); a color pixel for detecting a signal conforming to an amount of incident light of green color (G); and a color pixel for detecting a signal conforming to an amount of incident light of blue color (B). The imaging element 11 may also be of another type, such as CMOS, rather than of a CCD type.

The CPU 15 drives the imaging element 11 as will be described in detail later by way of an imaging element drive section 20 and outputs a subject image captured through the imaging lens 10 as a color signal. A user's instruction signal is input to the CPU 15 by way of an operation section 21, and the CPU 15 performs various types of control operations in accordance with the instruction.

An operation section 21 includes a shutter button; performs focusing control when a shutter button is pressed halfway (a switch S1); and performs imaging operation when the shutter button is pressed all the way (a switch S2).

An electric control system of the digital still camera has an analogue signal processing section 22 connected to an output of the imaging element 11 and an A-D converter circuit 23 that converts ROB color signals output from the analogue signal processing section 22 and a brightness detection signal Y into digital signals, respectively. These sections are controlled by the CPU 15.

Moreover, the electric control system of the digital still camera has a memory control section 25 connected to main memory (frame memory) 24; a digital signal processing section 26 for performing signal processing to be described in detail later; a compression/decompression processing section 27 for compressing a captured image into a JPEG image or decompressing the JPEG image; a totalizing section 28 that totalizes photometric data, to thus adjust a gain of white balance; an external memory control section 30 connected to a removable recording medium 29; and a display control section 32 connected to a liquid-crystal display section 31 incorporated in a rear of a camera, or the like. These sections are interconnected by means of a control bus 33 and a data bus 34 and controlled by a command from the CPU 15.

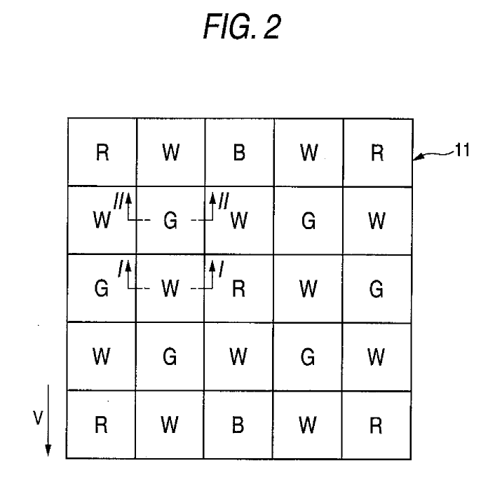

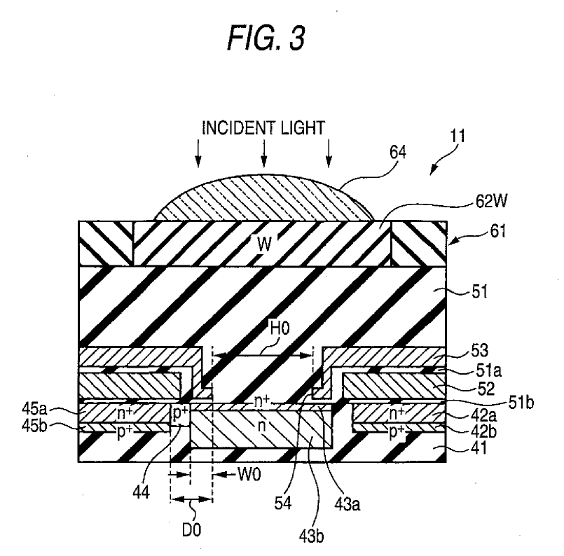

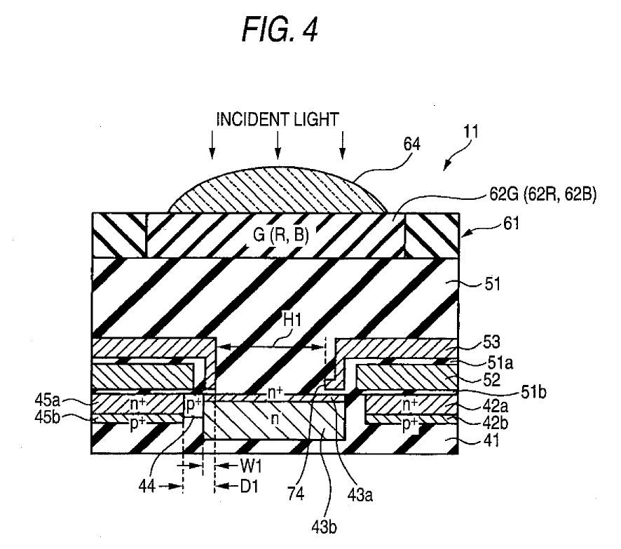

FIG. 2 is a plan view simply showing an arrangement of pixels in an imaging region of the imaging element 11. FIG. 3 is a cross-sectional view of the arrangement of the pixels in FIG. 2 when viewed in the direction of arrow I-I. FIG. 4 is a cross-sectional view of the arrangement of the pixels in FIG. 2 when viewed in the direction of arrow II-II.

The imaging element 11 has a semiconductor substrate 41, such as silicon, and a plurality of impurity diffusion layers are formed, by means of ion doping, on a surface of the semiconductor substrate 41 exposed to incident light. Specifically, charge storage regions 43a consisting of a heavily-concentrated n-type impurity diffusion layer and photoelectric conversion regions 43b consisting of an n-type impurity diffusion layer below the respective charge storage region 43a are formed on the surface of the semiconductor substrate 41. The charge storage regions 43a and the photoelectric conversion regions 43b subject received incident light to photoelectric conversion, thereby acting as photoelectric conversion sections that generate signal charges.

Charge transfer regions 42a consisting of a heavily-concentrated n-type impurity diffusion layer and heavily-concentrated p-type impurity diffusion layers 42b formed below the respective charge transfer regions 42a are formed on the surface of the semiconductor substrate 41 while being spaced apart from the charge storage regions 43a and the photoelectric conversion regions 43b (right-hand side in FIG. 3). In accordance with a read pulse input from the imaging element drive section 20 during driving operation, the charge transfer regions 42a read signal charges developed in the photoelectric conversion regions 43b of pixels located on the left side of the charge transfer regions. Element isolation regions 44 consisting of a heavily-concentrated p-type impurity diffusion layer are formed on the right side of the respective charge storage regions 43a and the respective photoelectric conversion regions 43b. Charge storage regions 45a and photoelectric conversion regions 45b for reading signal charges of photoelectric conversion sections of pixels adjacent to the charge storage regions 43a and the photoelectric conversion regions 43b are likewise provided adjacent to the charge storage regions 43a and the photoelectric conversion regions 43b by way of respective element isolation regions 44.

Charge transfer electrodes 52 consisting of polysilicon, or the like, are provided on the front side of the semiconductor substrate 41 by way of an interlayer insulation film 51b. In the imaging element 11 of the present embodiment, the charge transfer electrodes 52 act as vertical charge transfer sections that vertically transfer signal charges read from the photoelectric conversion section during driving operation.

Light-shielding films 53 consisting of aluminum, or the like, are formed on the respective charge transfer electrodes 52 by way of the interlayer dielectric films 51a. An opening section 54 having a predetermined open area is opened at a position on each light-shielding film 53 located above the charge storage region 43a and the photoelectric conversion region 43b. The opening sections 54 can be formed by forming the light-shielding film 53 over the entirety of the semiconductor substrate 41; exposing the light-shielding film through use of a predetermined mask pattern in a photolithography step; and subjecting the substrate to etching.

A transparent insulation layer 51 is stacked on the light-shielding films 53, and color filters 61 are formed on the insulation layer 51. The color filter layer 61 has a filter of R color for decomposing light of a red color component; a filter of C color for decomposing light of a green color component; and a filter of B color for decomposing light of a blue color component. Further, the color filter 61 has a brightness filter enabling transmission of light having all color components.

For instance, an ND filter, a transparent filter, a white filter, a gray filter, and the like, can be used for the brightness filter. In the present embodiment, the white filter is provided, and W brightness filters 62W are disposed above the respective photoelectric conversion sections of predetermined pixels as shown in FIG. 3. Nothing may also be provided at positions above the light-receiving surfaces of the respective photoelectric conversion sections, thereby allowing incident light to directly enter the light-receiving surfaces. Even in the case of such a configuration, the invention of the present patent application, a brightness filter can be provided substantially.

Convex micro lenses 64, each of which has a curved surface protruding toward a side exposed to incident light, are provided on surfaces of the respective color filter layers 61.

As shown in FIG. 2, in the imaging element 11 of the present embodiment, the arrangement of pixels in the imaging region has a pattern in which R pixels having the R color filter, G pixels having the G color filter, B pixels having the B color filter, and W pixels having the W brightness filter are arranged two-dimensionally with respect to the imaging region. Specifically, a column in which the R pixels and the B pixels are arranged one after another with the W pixels sandwiched therebetween, like the R pixel, the W pixel, the B pixel, the W pixels, the R pixel, . . . , in the vertical direction in FIG. 2 and a column in which the W pixels and the G pixels are arranged one after another, like the W pixel, the G pixel, the W pixel, the G pixel, the W pixel, . . . , are arranged one after another in the horizontal direction. Here, the W pixels are arranged so as not to be positioned side by side in both the vertical and horizontal directions.

During imaging operation, the imaging element 11 acquires color information by means of the R pixels, the G pixels, and the B pixels and brightness information by means of the W pixels.

In the imaging element 11 of the present embodiment, the vertical charge transfer sections are disposed so as to extend in the direction of arrow V in FIG. 2 among the thus-arranged columns of pixels. Unillustrated horizontal charge transfer sections are connected to respective ends of the vertical charge transfer sections with respect to a transfer direction, and the signal charges transferred along the horizontal charge transfer sections are output from an output amplifier.

As shown in FIG. 3, in each of the W pixels, a horizontal dimension of the opening section 54 of the light-shielding film 53 is taken as H0; a horizontal distance between the reading region 45a of the pixel that is adjacent to the W pixel and that has any of the R, G, and B filters and an open edge of the open section 54 is taken as D0; and a horizontal distance of an area where the light-shielding film 53 and the photoelectric conversion section vertically overlap each other is taken as W0. In each of the G pixels (the same also applies to the R and B pixels) where the color filter is disposed, a horizontal dimension of an opening section 74 of the light-shielding film 53 is taken as H1; a horizontal distance between the reading region 45a of the W pixel adjacent to the G pixel and an open edge of the open section 74 is taken as D1; and a horizontal distance of an area where the light-shielding film 53 and the photoelectric conversion section vertically overlap each other is taken as W1.

In the imaging element of the present embodiment, the opening section 54 of the light-shielding film 53 of the G (R and B) pixel, where the color filter is disposed, is smaller than the opening section 54 of the W pixel in terms of the horizontal distance D1 between the reading region of the pixel having the brightness filter adjacent to the color filter and the open edge of the opening section 74. Put another way, the opening section 74 of the light-shielding film 53 of the G (R and B) pixel where the color filter is disposed spreads toward the reading regions 45a of the adjacent W pixels when compared with the opening section 54 of the W pixel. The distance W1 of the area where the light-shielding film 53 of the W pixel covers the photoelectric conversion section is smaller than the distance W0 of the area where the light-shielding film 53 of the W pixel covers the photoelectric conversion section.

According to the configuration of the embodiment, the opening sections 74 of the R, G, and B pixels having the color filters are made smaller than the opening section 54 of the W pixel having the brightness filter in terms of the horizontal distance D1 between the reading region 45a of the W pixel having the brightness filter adjacent to the color filter and the open edge of the opening section 74, whereby the opening section 74 can be formed so as to become greater toward the W pixel having the brightness filter when the imaging element is viewed from the direction where incident light is radiated. In order to acquire brightness information, signal charges are used for the W pixels having the brightness filters. Even if a portion of the light falling on the color filter is radiated on the charge storage region 45a of the W pixel having the brightness filter adjacent to the color filter, a smear signal will not be generated, and therefore a pseudo color will not arise. In the R, G, and B pixels having the color filters, amounts of light received by the photoelectric conversion sections can be increased by increasing the opening sections 74, so that optical sensitivity can be enhanced and that brightness shading can be improved.

The present invention is not limited to the previously-described embodiment and susceptible to various modifications or improvements.

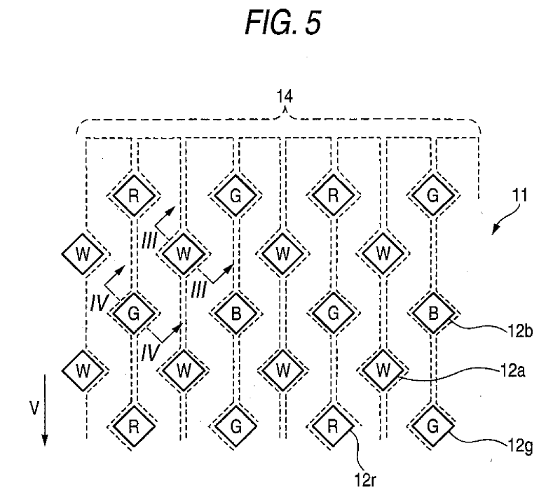

For example, the pixels of the imaging element may also assume an arrangement pattern shown in FIG. 5. In the imaging element shown in FIG. 5, the color filter layers are arranged in a grid pattern in such a way that the R, G, and B pixels having color filters for decomposing incident light into red, bluer and green colors and the W pixels having color filters arranged in a grid pattern at essentially-equal intervals in both the vertical and horizontal directions of the imaging region as well as having a brightness filter are offset from each other at one-half of each of the vertical and horizontal intervals of the color filters. The pixel arrangement is essentially equal to the arrangement shown in FIG. 4 that is tilted clockwise by 45 degrees. In the imaging element of such a pixel arrangement, the vertical charge transfer sections 14 indicated by lines in FIG. 5 are provided among the rows of pixels. The vertical charge transfer sections 14 read signal charges of the respective pixels along the column and vertically transfer the thus-read charges in the direction of arrow V. A cross-sectional profile when viewed from direction of arrow III-III in FIG. 5 and a cross-sectional profile when viewed from direction of arrow IV-IV in the same drawing become analogous to the configurations shown in FIGS. 3 and 4 of the previous embodiment. The opening sections of the light-shielding films of the R, G, and B pixels where color filters are disposed can be formed so as to become smaller than the opening section of the W pixel having the brightness filter in terms of the horizontal distance between the reading area of the pixel having an adjacent brightness filter and the open edge of the opening section. By means of the configuration, occurrence of smear can be prevented, and optical sensitivity of the pixels having the color filters can be enhanced.

The present invention enables provision of an imaging element and an imaging device that can prevent occurrence of smear and enhance optical sensitivity.

The entire disclosure of each and every foreign patent application from which the benefit of foreign priority has been claimed in the present application is incorporated herein by reference, as if fully set forth.

What is claimed is:

1. An imaging element that generates a signal charge by photoelectric conversion of incident light in each of a plurality of pixels provided in an imaging region, the element comprising:
a semiconductor substrate;
a plurality of photoelectric conversion sections arranged two-dimensionally on a surface of a semiconductor substrate;
a color filter layer that comprises (i) a plurality of color filters that decomposes incident light into different colors and (ii) a plurality of brightness filters that causes light including all color components to pass, said plurality of color filters and said plurality of brightness filters being arranged at positions above said plurality of photoelectric conversion sections respectively so as to form the pixels;
vertical charge transfer sections linearly extended so as to transfer signal charges read from said plurality of respective photoelectric conversion sections;
reading regions that respectively read signal charges generated by the photoelectric conversion sections to the vertical charge transfer sections; and
light-shielding films that are provided so as to cover the vertical charge transfer sections and have opening sections located above the respective photoelectric conversion sections,
wherein the opening sections comprises: first opening sections that correspond to a first subset of ones of the pixels in which the color filters are disposed; and second opening sections that correspond to a second subset of ones of the pixels in which the brightness filters are disposed, and
wherein when a horizontal distance between: an edge of one of the second opening sections which corresponds to first one of the second subset of ones of the pixels; and one of the reading regions which corresponds to first one of the first subset of ones of the pixels, the first one of the first subset of ones of the pixels being adjacent to the first one of the second subset of ones of the pixels, is a first distance, and
when a horizontal distance between: an edge of one of the first opening sections which corresponds to second one of the first subset of ones of the pixels; and one of the reading regions which corresponds to second one of the second subset of ones of the pixels, the second one of the second subset of ones of the pixels being adjacent to the second one of the first subset of ones of the pixels, is a second distance,
the first distance is smaller than the second distance.

2. The imaging element according to claim 1,
wherein said plurality of color filters are color filters that decompose incident light into red, green, and blue colors, and
the color filters and the brightness filters are arranged in a grid pattern at essentially equal intervals in both vertical and horizontal directions of the imaging region.

3. The imaging element according to claim 1,
wherein said plurality of color filters are color filters that decompose incident light into red, green, and blue colors,
the color filters are arranged in a grid pattern at essentially equal intervals in both vertical and horizontal directions of the imaging region, and
the brightness filters are arranged in a grid pattern so as to become offset from each other at one-half of each of the vertical and horizontal intervals of the color filters.

4. An imaging device comprising the imaging element defined according to claim 1.
